(19) United States
(12) Patent Application Publication
(10) Pub. No.: US 2012/0128902 A1
(43) Pub. Date: May 24, 2012

(54) Coated Printing Substrate

(76) Inventor: Leonardo Panettieri, Pisa (IT)

(21) Appl. No.: 13/387,922

(22) PCT Filed: Jul. 23, 2010
(86) PCT No.: PCT/IB10/53365

§ 371 Date: Jan. 30, 2012

(30) Foreign Application Priority Data
Jul. 31, 2009 (IT) PI2009A000097

(51) Int. Cl. B41M 5/00; B41M 5/40; B05D 7/00; B05D 5/00; B05C 9/12

(52) U.S. Cl. 428/32.18; 427/288; 118/59; 428/32.31

(57) ABSTRACT

A coated printing substrate, preferably for offset or inkjet printing, comprises a coating composed of a water eraulsifiable binder, calcium carbonate or sulphate, a granular material of the grain size of a flour or a fine sand, and water. BGy a proper production method can be obtained a product which can be produced at industrial level with low costs and it is particularly suitable for the reproduction of photos or art pieces such as paintings or frescos as it gives the visual and tactile sensations of such kinds of art pieces, allowing, at the same time, high quality printing.

### FIELD OF THE INVENTION

The present invention relates to a coated substrate suitable for printing, said substrate being made of paper, cardboard, or the like.

The invention relates also to a method for making a coated substrate suitable form printing and to its use.

### DESCRIPTION OF THE PRIOR ART

In the sector of paper for printing machines are known many types of coated paper having coatings of any composition and thickness for giving the substrate features for a better printing or for obtaining particular aesthetic effects, and many patents have been filed on the matter.

For instance, they are known printing substrates provided with coatings which gives the substrate a peculiar brightness and evenness which are desirable for obtaining specific decorative effects, for photographic printing, and in particular for products which would be metalized in a later time. For instance, patent documents U.S. Pat. No. 5,334,449, DE-B-1233248, U.S. Pat. No. 3,113,888 describe printing substrates having, among other features, the above cited features.

Another type of printing substrates have surface visual effects, such as a not uniform color. Such type of substrates, or their production processes, are described for instance in EP 1439263 and EP 1239077.

Among paper substrates with coatings for conferring peculiar visual effects there are products which are particularly suitable for the reproduction of paintings or murals as they have superficial effects which reproduce, for instance, the weft of a canvas, or the granulosity and mat aspect of a fresco.

Nevertheless, no known substrate suitable to be printed through the most common printing processes, such as the inkjet process or the offset process, is able to substantially reproduce all the visual and tactile sensations of paintings and/or murals so making it possible to print art pieces reproductions of great quality in a very simple and cost effective way.

### SUMMARY OF THE INVENTION

The object of the present invention is to propose a coated printing substrate having visual and tactile surface features suitable for reproducing the visual and tactile features of paintings and/or frescos.

Further object of the present invention is to propose a low cost coated printing substrate for printing painting, frescos or photo reproductions.

Another object of the present invention is to propose a coated printing substrate which have a cost effective and easy to apply coating.

Another object of the present invention is to propose a method for making a coated printing substrate particularly suitable for printing paintings, frescos or photo reproductions.

Another object of the present invention is to propose a paper having a printable coating which can be hardly bent without breaking the coating and that at the same time has a consistency to touch similar to a mural.

The above objects are attained by a printing substrate having, on at least one surface, a coating having thickness from 40 to 400 micron and it is formed by a

mixture comprising: from 5 to 40 parts by weight of a water emulsifiable binder, from 10 to 60 parts by weight of calcium salts, from 1 to 40 parts by weight of granular material in an average particle size ranging from 20 micron to 150 micron, and from 20 to 50 parts by weight of water.

The consistency of the coating gives the printing substrate visual and tactile features which are peculiar in paintings or murals, and they can be made at industrial level at a low cost as it can be easily argued from the mixture composition.

In particular, the granular material gives the printing substrate a specific roughness and coarseness suitable to reproduce the consistency of paintings or murals.

The coating has a great mechanical strength and, mainly when the substrate is made of paper, canvas or other porous material, the coating permanently adheres to the substrate.

A printing substrate as above defined also grants a very good adhesion of the color and high print quality as concern color and resolution.

Advantageously the substrate is paper and, in the coating the calcium salts are calcium carbonate and/or calcium sulphate, the granular material is siliceous and/or calcareous material, preferably mainly composed of silicium dioxide and the binder is an acrylic resin.

The use of calcium carbonate and silicium dioxide allow a low cost of the printing substrate as they are substances of great diffusion and low cost.

In preferred embodiments of the substrate of the present invention the binder is in an amount from 20 to 50 parts by weight, the calcium salts is from 5 to 40 parts by weight, the granular material is from 5 to 40 parts by weight and the water is from 20 to 50 parts by weight.

The above ranges lead to the best features of the substrate ad concerns elasticity and mechanical strength of the coating and the ability of permanently fix the color.

The mixture which forms the coating preferably has a density from 1.1 to 2 gr/cm³.

Advantageously on the surface of the coating is obtained a texture having depth from 10 to 500 micron.

The above features is suitable for emphasizing the characteristics of the printing substrate in order to print paintings, frescos or photo reproduction which are as similar as possible to the originals. The above objects are also attained through a method for making a coated printing substrate comprising steps of:
applying on a surface of said substrate a layer having thickness from 25 to 1000 micron of a mixture comprising: from 5 to 70 parts by weight of a water emulsifiable binder, from 1 to 60 parts by weight of calcium salts, from 1 to 60 parts by weight of granular material in an average particle size ranging from 20 micron to 1000 micron, and from 10 to 60 parts by weight of water,
passing said substrate with said layer of mixture through a soft unsmooth roller,
drying said layer until a coating adhering to said substrate is obtained.

Preferably the above method is performed in a plant for applying thin films on a paper substrate comprising an unwinder of a paper web, a machine for applying a mixture on the paper web, one or more drying chambers and a rewinder, in which between a phase of applying the mixture on the paper web and a first drying phase there is a phase of pressing the mixture an the paper web by passing them through pairs of pressing rollers.

Advantageously between two subsequent pairs of pressing rollers the coated printing substrate is passed under air jets directed toward the surface of the mixture to accelerate the drying process.

Still advantageously the pressing rollers which are on the side of the mixture are made of polyurethane with open and/or closed cells.

### BRIEF DESCRIPTION OF DRAWINGS

These and other characteristics of the invention will become more easily comprehensible from the following description of the preferred embodiments of the invention, given as not limiting examples, with reference to the enclosed drawings, in which:

FIG. 1 is a schematic side view of a plant for producing a coated printing substrate according to the present invention;

FIG. 2 is a schematic view of some components of the plant of FIG. 1;

FIG. 3 is a perspective view of a portion of a coated printing substrate according to the present invention.

### DETAILED DESCRIPTION OF PREFERRED EMBODIMENTS

Preferred embodiments of the invention for obtaining coated substrates, in particular a coated paper suitable for printing with inkjet or offset printers, will be described in the followings.

According to a general way of producing a coated printing substrate according to the present invention it is made a mixture according to the invention having density of 1.5 gr/cm³, such that the granular particles that it contains remains in suspension for a time long enough to grant the homogeneity of the mixture when it is spread on the substrate.

In some cases, for a long conservation, the mixture can be stored with a low amount of water in it and it can be diluted just before the use.

On a printing substrate, which is preferably printing paper ranging from 80 to 450 gr/m², but that in specific cases could also be cardboard, canvas, wood or other material, the mixture is applied so that an even thickness is obtained, for instance by machines using rollers, pads, blades or the like, or also by spraying devices.

Just after the mixture has been applied the substrate is passed through contact means suitable for improving the adhesion of the coating to the substrate and also useful to promote the creation of random patterns which are mainly due to the material of which said contact means are made, and to the composition and viscosity of the mixture. For instance, in a specific embodiment a soft unsmooth roller, preferably a sponge, is passed on the surface of the mixture for making the surface even and creating a texture whose depth and pattern are due to the pattern on the surface of the roller, to its elasticity and to the consistency of the mixture. Alternatively, if the mixture is sprayed on the substrate the sponge roller can be avoided as the mixture could already have the suitable roughness.

The substrate is then dried in a aired environment with humidity under control and after about 5 minutes it is obtained a coated substrate suitable for printing with inkjet or offset printers and for reproducing art pieces such as paintings, frescos or photos.

In fact, the consistency of the coating together with the pattern due to the soft roller give the coated substrate great similarity both on visual and tactile point of view, to a painted canvas or to a mural.

In order to obtain a specific smoothness of the coated surface the coated substrate can be subject to a smoothing process performed through specific rollers suitable for machining the crests of the surface, which are mainly composed of granular material, without creating a highly smooth surface.

In addiction, conventional transparent finishings can be applied to the coated substrate in order to improve brightness.

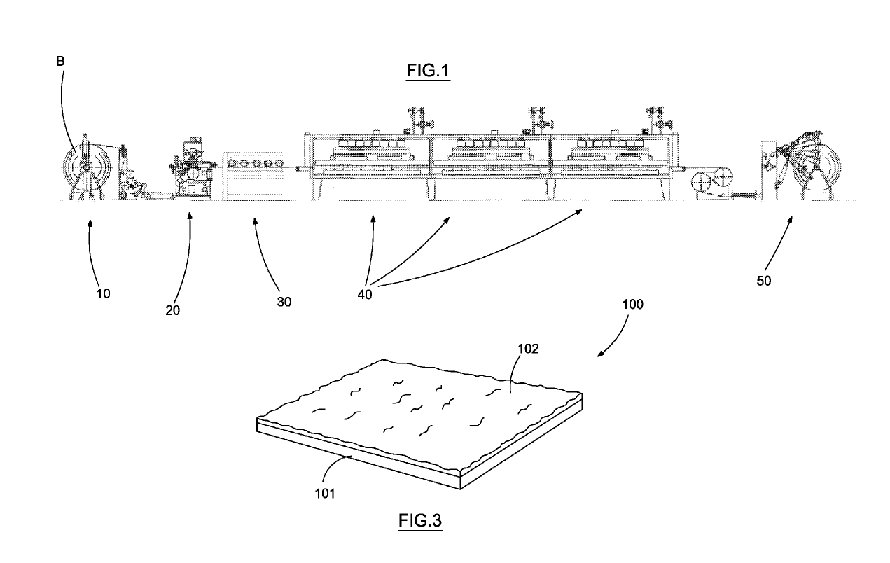

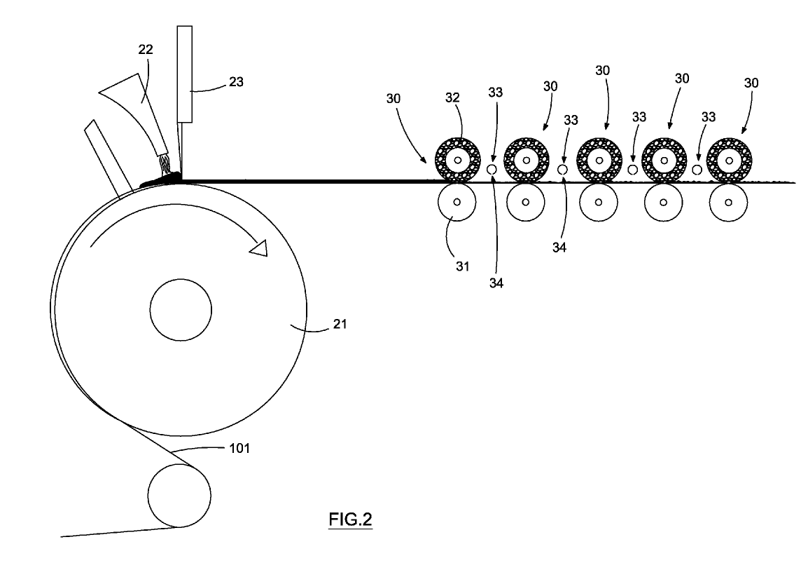

A different specific way of realizing a coated printing substrate according to the present invention will be now described with reference to FIGS. 1 and 2 and it is used for making a product that has good ability to keep the color, good printability (mainly by offset and inkjet printers) and good bendability with no risk of creeping or detachment of the coating from the paper, and it has consistency to touch and aesthetic appearance which are peculiar of whitewashed walls. Such a product is useful for printing images so that it seems, under both visual and tactile point of views, to be directly made on a whitewashed wall even if it is printed on a sheet paper that can be managed, stored and handled with the easiness of the paper. For instance, reproductions of frescos, photos or famous murals can be printed, both in real dimension and in scale, and it can also be used for making samples suitable to show which will be the visual and tactil aspect of an image the will be made on a whitewashed wall.

A product with the above features can be realized in a plant which has a layout very similar to plants for gluing plastic films or fabrics on substrate which are paper or other fabrics. In fact, a plant for producing a coated printing substrate according to the present invention comprises an unwinder, 10, a blade type mixture applying machine, 20, a set of pairs of pressing rollers, 30, drying chambers, 40, and a rewinder, 50.

A web, B, of paper material, 101 (see FIG. 3), is loaded in the unwinder 10 and it is the substrate on a side of which a coating, 102 (see FIG. 3) is applied.

The paper material unwound from the web is fed to the mixture applying machine 20 where the web turns about a cylinder member, 21 and a mixture feeder, 22, applies a fluid mixture according to the invention on the top surface of the paper substrate, 101, then, at the point where the web leaves the periphery of the cylinder member, 21, a blade, 23, adjust the amount of fluid mixture that remains on the surface of the paper material 101. The amount of fluid mixture remaining on the substrate is very high. In fact, while in the production of conventional coated paper the amount of product applied on the substrate is no more than 30 gr/m², in the method of the present invention the amount of fluid mixture remaining on the paper substrate is variable in a range from 120 to 350 gr/m². Then, the paper web with the fluid mixture on one side is passed through a set of pairs of pressing rollers 30 for pressing the fluid mixture on the substrate so that it promotes adhesion and the creation of random patterns. In fact, the viscosity of the mixture and the surface of the rollers generate adhesive forces between the two surfaces (forces which are variable as a function of the composition of the mixture, its viscosity, the material of the surface of the rollers, and the morphology of the surface of the rollers) such that surface movements take place in the coating which create random tridimensional patterns. The above effect is greater in the first pairs of pressing rollers, when the mixture is less viscous, while it decreases as long as the mixture solidifies. Each pair of pressing rollers 30 is made of a lower roller, 31, substantially smooth, and a top roller, 32, made of polyurethane or the like, with closed or open cells depending on the kind of desired surface effect (roughness of the surface). The use of polyurethane is very suitable as it has a proper paper adhesion coefficient and the elasticity of that material is such that it allows exerting the right pressure on the paper. Between a pair of rollers and the following pair are placed air inlet ducts, 33, provided with air nozzles, 34, suitable for emitting jets of compressed air towards the surface of the fluid mixture in order to promote drying. The pressure, the temperature and the humidity of the air emitted towards the surface of the mixture are properly controlled for obtaining the best drying conditions. Subsequently, the paper web is passed through a set of drying chambers 40, where, at controlled humidity and temperature, it ends drying. Once come out of the drying chambers 40 the paper web is wound by a rewinder 50.

With regard to conventional plants for applying coatings on a paper substrate, the plant for producing coated printing paper according to the invention has a much lower web feeding speed in order to allow the coating to correctly dry. In fact, while conventional paper coating plants has a web feeding speed ranging between 50 and 600 m/min, the plant of the present invention has a speed comprised between 4 and 20 m/min.

In FIG. 3 is shown a portion of a coated printing paper, 100, according to the present invention which is composed of a sheet of paper material, 101, and a layer of coating, 102, made with a dried mixture according to the present invention. Usually, the side of the paper side of the product 100 is substantially smooth, while the coating side 102 has a greater roughness, could be characterized by a random pattern, and it has a visual and tactile aspect which are typical of whitewashed walls. Though it has the above aspect, the product 100 according to the invention keeps the advantages of a printing paper and, in particular, its thickness, the bendability without fractures in the coating and the ability to fix the inks.

In the followings will be described in detail to examples of coated substrates, which have to be intended are mere, not limiting examples of the invention.

### Example 1

### Printing Substrate for Inkjet Printers Using Water Inks or Resin Based Inks

On a paper substrate with a weight of 150 gr/m² is applied a layer of about 250 micron of a mixture composed of:
35% by weight of acrylic resin,
28% by weight of calcium carbonate,
6% by weight of quartz flour with an average grain size of 40 micron,
31% by weight of water,
traces of titan dioxide as a pigment,
traces of wetting and/or fluidizing additives.

Before drying the mixture is passed with a sponge roller for obtaining a pattern of about 100 micron of thickness.

### Example 1

### Printing Substrate for Inkjet Printers Using Solvent Inks

On a paper substrate with a weight of 250 gr/m² is applied a layer of about 300 micron of a mixture composed of:
40% by weight of acrylic resin,
20% by weight of calcium carbonate,
10% by weight of quartz flour with an average grain size of 100 micron,
30% by weight of water,
traces of titan dioxide as a pigment,
traces of wetting and/or fluidizing additives.

Before drying the mixture is passed with a sponge roller for obtaining a pattern of about 150 micron of thickness.

After drying a smoothing process is performed so that the coating is smooth to touch even if it appears irregular at sight.

As it would be obvious to the people skilled in the sector, mixture such as the above described are not used in the known art for producing coated paper but, they are similar as concern the composition to wall whitewashing substances or to wall paints. In fact, for instance, the binder used in the above examples is acrylic resin which is used in wall paints. Acrylic resins are also used for paper coatings but in paper products which have a very different destination of use with respect to the paper product of the present invention. Vinyl and/or versatic resins may also be used, and just like the acrylic resins they are not usually used for making coated paper for offset or inkjet printing. In addiction, calcium salts (mainly calcium carbonate), which in conventional coated papers are used in very low amount to avoid flouring and to prevent a problem in fixing the printing ink, in the above example are over 20% by weight and they may arrive to 40% which is a value typical of wall paints and wall whitewashing substances, and they give the final product the consistency of this last products. Even quartz flour is not usually used in coatings for offset or inkjet printing paper, while it is very common in exterior wall paints. The use of substances like calcium carbonate and quartz flour, which is common in paints, gives the product of the invention the consistency and the aesthetic aspect of whitewashed walls and, therefore, an image printed on the product of the invention seems directly made on a wall. Despite of the above similarities with wall paints, the other components of the coating of the present invention, and their percentages, are very important in order to obtain a good adhesion to the paper substrate, and good printing properties and they are therefore function of the kind of printings and inks for which the product is intended.

Certainly, with respect to the above described examples, many changes can be carried out both to the coated substrate production process and to the composition of the mixture which form the coating.

For instance, the water emulsifiable binder could be a vinyl, vinyl-versatic, silossanic resin, potassium silicate or other products having similar properties.

Though calcium carbonate is very cheap and it assures good performances, a different calcium salt can be used, such as a calcium sulphate, or a mixture of both.

The granular material is quartz flour in the examples, mainly composed of silicium dioxide with a grain size such that it gives the proper consistency to the coating, but any granular material could be used, both mineral and synthetic.

Further components can be added to the mixture in little amounts. In the above examples titanium dioxide is added for obtaining a with color of the coating, but, obviously, pigments of any other type can be added and additives for improving wetting or fluidity such as polysaccharides or tensioactives.

These and other changes or modifications could be applied to the coated printing substrate according to the invention or to the relating production method, still remaining within the protective scope defined by the following claims.

1. Coated printing substrate in which said substrate has a coating on at least one surface characterized in that said coating has a thickness from 25 micron to 400 micron and is formed by a mixture comprising (a) 5 to 40 parts by weight of a water emulsifiable binder comprising a vinyl versatic, (b) from 10 to 60 parts by weight of calcium, (c) from 1 to 40 parts by weight of siliceous calcareous granular said granular material exhibiting an average particle size ranging from 20 micron to 150 microns, and (d) from 20 to 40 parts by weight of water.

2. Coated printing substrate according to claim 1 characterized in that said calcium salts are calcium carbonate and/or calcium sulphate.

3. Coated printing substrate according to claim 1 characterized in that said granular material is a quartz flour.

4. Coated printing substrate according to claim 1 characterized in that said binder is an acrylic resin.

5. Coated printing substrate according to claim 1 characterized in that said substrate is a printing paper with a weight ranging between 80 and 300 gr/m².

6. Coated printing substrate according to claim 1 characterized in that in said mixture said binder is a vinyl versatic resin from 5 to 20 parts by weight, said calcium salts are calcium carbonate from 15 to 40 parts by weight, said granular material has an average particle size from 30 to 150 micron and it is in an amount ranging from 5 to 40 parts by weight, and the water is from 20 to 60 parts by weight.

7. Coated printing substrate according to claim 1 claim characterized in that said mixture has density from 1.1 to 2 gr/cm³.

8. Coated printing substrate according to claim 1 characterized in that on the surface of said coating is realized a pattern having a thickness of between 10 and 500 micron.

9. Coated printing substrate according to claim 1 wherein said coated substrate is a coated paper suitable for printing with offset or inkjet printers and it has tactile and visual properties which are characteristic of a whitewashed wall.

10. Method for producing a coated printing substrate characterized in that said substrate is a paper web and said method comprises the steps of:
applying on a side of said paper web a layer having a thickness of from 25 to 400 microns of a mixture (102) comprising: (a) from 5 to 40 parts by weight of a water emulsifiable binder comprising a vinyl versatic, (b) from 10 to 60 parts by weight of calcium, (c) from 1 to 40 parts by weight of siliceous calcareous granular said granular material exhibiting an average particle size ranging from 20 micron to 150 microns, and (d) from 20 to 40 parts by weight of water
passing said substrate with said layer of mixture through a soft unsmooth drying roller; and
drying said layer until a coating adhering to said substrate is obtained.

11. Method according to claim 10 comprising steps of:
passing said paper web (101) with said mixture (102) through pairs of pressing rollers (30) for pressing the mixture on the paper substrate in order to promote adhesion and the creation of random patterns:
passing said paper web through one or more drying chambers at controlled temperature and humidity.

12. Method according to claim 11 wherein the pressing rollers (32) on the side of the mixture are made of polyurethane with open and/or closed cells.

13. Method according to claim 11 wherein, at between sequential pairs of pressing rollers (32), jets of compressed air are emitted towards the surface of the fluid mixture in order to promote drying.

14. Method according to claim 13 wherein said compressed air is at controlled pressure, temperature and/or humidity.

15. Method according to claim 10 wherein in said mixture said water emulsifiable binder is a vinyl and/or versatic resin and said calcium salts are calcium carbonate.

16. Method according to claim 10 wherein in said step of applying the mixture on the paper web, said mixture it is applied at an amount within the range of mixture ranging from 50 to 350 gr/m².

17. Method according to claim 10 characterized in that, after said drying step, one or more steps of smoothing said coating are carried out.

18. Plant for producing coated printing paper comprising:
an unwinder (10) of a paper web,
a blade type mixture applying machine (20) for applying a fluid mixture on a side of said paper web,
sequential pairs of pressing rollers (30) through which is passed the paper web having said mixture on one side,
drying chambers (40), and
a rewinder (50) for winding the obtained product,
characterized in that between said sequential pairs of pressing rollers (30) are placed air inlet ducts (33) provided with air nozzles (34) suitable for emitting jets of compressed air towards the surface of the fluid mixture in order to promote drying.

19. Plant for producing a coated paper according to claim 18 wherein the surface of the pressing rollers (32) on the side of the mixture is made of polyurethane with open and/or closed cells.
